(19) United States
(12) Patent Application Publication
(10) Pub. No.: US 2021/0362813 A1
(43) Pub. Date: Nov. 25, 2021

(54) Surfboard Hanger

(71) Applicant: Tal Amos, Ashkelon (IL)

(72) Inventor: Tal Amos, Ashkelon (IL)

(73) Assignee: Tal Amos, Ashkelon (IL)

(21) Appl. No.: 16/879,282

(22) Filed: May 20, 2020

(51) Int. Cl. B63B 32/83; F16B 2/00; F16B 45/00; F16M 13/02

(52) U.S. Cl. CPC B63B 32/83; F16M 13/02; F16B 45/00; F16B 2/005

(57) ABSTRACT

This paper is directed to a system for the storage and display of large objects, such as surfboards. The system disclosed herein holds a surfboard vertically via the leash plug. The system may use hook on a hanger to hold a leash attached to the leash plug. A variant of the system uses a bumper, either above or below the hook, to hold help hold the surfboard in place. An additional variant of the system may use a hook directly attached to the leash plug.

### FIELD

The present disclosure relates to an apparatus for a modular hanging device to store large and unusually shaped objects, such as a surfboard.

### BACKGROUND

Storage of sports boards such as surfboards, skateboards, snowboards, wake boards, kite boards, skim boards, body boards, snow skis, and water skis when not in use presents a problem due to their large size and awkward shape. Retailers or sports enthusiasts typically have many boards of various types. Without a storage system a retailer may stack surfboards on a rack, lean them against the wall or stack them on the floor. This can be problematic because they take up floor space that could serve other uses, the boards can fall over or slide out at the bottom resulting in dents or scratches and damage to the board or surrounding area, it is difficult to grab a board in the middle of a pile for viewing or use without removing several other boards, and it is difficult to store different types of boards in the same stack. Other typical storage options include building or installing racks to stack the boards vertically along a wall which still resulting in loss of floor space, some potential for them to fall over causing damage, and it is difficult to store different board types in one rack type. Retailers or users may alternatively use wall or ceiling mounted racks that store the boards in a horizontal orientation. Rack and stacking based solutions however make it difficult to reach boards that are high on the rack or to quickly see a board and see additional features or artwork. Further, the racks have to be mechanically attached to the wall or ceiling and are not easily relocated, and can be expensive to purchase and install.

A solution is desirable, that does not involve a rack but still uses floor and wall area efficiently. A solution that allows the hanging of boards vertically has the advantage of utilizing the upper area of wall space, so the floor area below is less obstructed and can be used for other uses. Also, the boards have less potential of falling or sliding out resulting in damage; and it is easier to grab a board in the middle of a group of boards. A solution that uses an elevated rod can be used to support multiple board types without having to purchase and install various types of dedicated racks.

### SUMMARY

The present disclosure solves the above needs and deficiencies with known solutions for storing and displaying large objects, such as surfboards, in an elegant manner by providing an elevated rod and a modular hanger adapted to hang the board from the rod. In addition, many owners like to display their board for view in an elevated position. For example, the system disclosed herein may hold a surfboard vertically via the leash plug. The system may use hook on a hanger to hold a leash attached to the leash plug. A variant of the system may use a bumper, either above or below the hook, to hold help hold the surfboard in place without damaging it. In an additional embodiment, the system may use a hook directly attached to the leash plug.

In an additional embodiment, the hook portion of the hanger is separate form the hook portion and the two portions are attached at a modular attachment point. In this way the same hanger can be used with any of a plurality of hook designs disclosed.

This system allows for easy and appealing display of the surfboard. The surfboards are hung vertically from a pole. With this orientation it is easy for a customer to survey the surfboards and select the one they feel is most appealing.

### BRIEF DESCRIPTION OF THE DRAWINGS

The accompanying drawings illustrate various non-limiting examples and innovative aspects of the surfboard hander in accordance with the present description:

FIG. 1 is a diagram of a leash rope adapter with a bottom bumper.

FIG. 2 is a side view of a leash rope adapter with a bottom bumper.

FIG. 3 is an isometric view of a leash rope adapter with a bottom bumper.

FIG. 4 is a front view of a leash rope adapter with a bottom bumper.

FIG. 5 is a rear view of a leash rope adapter with a bottom bumper.

FIG. 6 is a top view of a leash rope adapter with a bottom bumper.

FIG. 7 is a bottom view of a leash rope adapter with a bottom bumper.

FIG. 8 is a diagram of a leash rope adapter with a top bumper.

FIG. 9 is a side view of a leash rope adapter with a top bumper.

FIG. 10 is an isometric view of a leash rope adapter with a top bumper.

FIG. 11 is a front view of a leash rope adapter with a top bumper.

FIG. 12 is a rear view of a leash rope adapter with a top bumper.

FIG. 13 is a top view of a leash rope adapter with a top bumper.

FIG. 14 is a bottom view of a leash rope adapter with a top bumper.

FIG. 15 is a diagram of a leash plug adapter.

FIG. 16 is a side view of a leash plug adapter.

FIG. 17 is an isometric view of a leash plug adapter.

FIG. 18 is a front view of a leash plug adapter.

FIG. 19 is a rear view of a leash plug adapter.

FIG. 20 is a top view of a leash plug adapter.

FIG. 21 is a bottom view of a leash plug adapter.

FIG. 22 is a front view of a hanger module.

FIG. 23 is an angled view of a hanger module.

FIG. 24 is a side view of a hanger module.

FIG. 25 is a side view of a hanger module.

FIG. 26 is a top view of a hanger module.

FIG. 27 is a bottom view of a hanger module.

FIG. 28 is an isometric view of a leash rope adapter with a bottom bumper attached to a hanger module.

FIG. 29 is a side view of a leash rope adapter with a bottom bumper attached to a hanger module.

FIG. 30 is an angled view of a leash rope adapter with a bottom bumper attached to a hanger module.

FIG. 31 is a front view of a leash rope adapter with a bottom bumper attached to a hanger module.

FIG. 32 is a rear view of a leash rope adapter with a bottom bumper attached to a hanger module.

FIG. 33 is an isometric view of a leash rope adapter with a top bumper attached to a hanger module.

FIG. 34 is a side view of a leash rope adapter with a top bumper attached to a hanger module.

FIG. 35 is an angled view of a leash rope adapter with a top bumper attached to a hanger module.

FIG. 36 is a front view of a leash rope adapter with a top bumper attached to a hanger module.

FIG. 37 is a rear view of a leash rope adapter with a top bumper attached to a hanger module.

FIG. 38 is an isometric view of a leash plug adapter attached to a hanger module.

FIG. 39 is a side view of a leash plug adapter attached to a hanger module.

FIG. 40 is an angled view of a leash plug adapter attached to a hanger module.

FIG. 41 is a front view of a leash plug adapter attached to a hanger module.

FIG. 42 is a rear view of a leash plug adapter attached to a hanger module.

FIG. 43 is an isometric view of a leash rope adapter with a bottom bumper and a hanger formed into a single unit.

FIG. 44 is a side view of a leash rope adapter with a bottom bumper and a hanger formed into a single unit.

FIG. 45 is an angled view of a leash rope adapter with a bottom bumper and a hanger formed into a single unit.

FIG. 46 is a front view of a leash rope adapter with a bottom bumper and a hanger formed into a single unit.

FIG. 47 is a rear view of a leash rope adapter with a bottom bumper and a hanger formed into a single unit.

FIG. 48 is an isometric view of a leash rope adapter with a top bumper and a hanger formed into a single unit.

FIG. 49 is a side view of a leash rope adapter with a top bumper and a hanger formed into a single unit.

FIG. 50 is an angled view of a leash rope adapter with a top bumper and a hanger formed into a single unit.

FIG. 51 is a front view of a leash rope adapter with a top bumper and a hanger formed into a single unit.

FIG. 52 is a rear view of a leash rope adapter with a top bumper and a hanger formed into a single unit.

FIG. 53 is an isometric view of a leash plug adapter and a hanger formed into a single unit.

FIG. 54 is a side view of a leash plug adapter and a hanger formed into a single unit.

FIG. 55 is an angled view of a leash plug adapter and a hanger formed into a single unit.

FIG. 56 is a front view of a leash plug adapter and a hanger formed into a single unit.

FIG. 57 is a rear view of a leash plug adapter and a hanger formed into a single unit.

### DETAILED DESCRIPTION

An improved surfboard hanging device is described herein. While the concepts of the disclosure will be disclosed and described in the context of a store or other retail environment for ease of explanation, it will be apparent to those of skill in the art that the same principles and methods can be applied to many applications in which objects are stored for display and retrieval.

Current means of storing surfboards involves interacting with the fins, clamping the board or other parts or providing a shelf for the surfboard to rest on. The present application is directed to multiple embodiments using the leash or the leash plug to suspend the surfboard vertically. The leash and the leash plug are typically securely attached to the rear of the surfboard making it an ideal spot to suspend the board's weight. Also, a system that stores the boards vertically reduces the square footage of the floor occupied by a board potentially allowing more boards to be stored in the same space and increases efficiency. The hanging system may also be modular and allow for the hanger element to be mated with several different supporting structures. For example, the boards could be hung by a variety of leash adapters and attached to a wall, a rack, a shelf or attached to a hanger module and hung on a pole.

Leash Rope Adapter with Bottom Bumper System

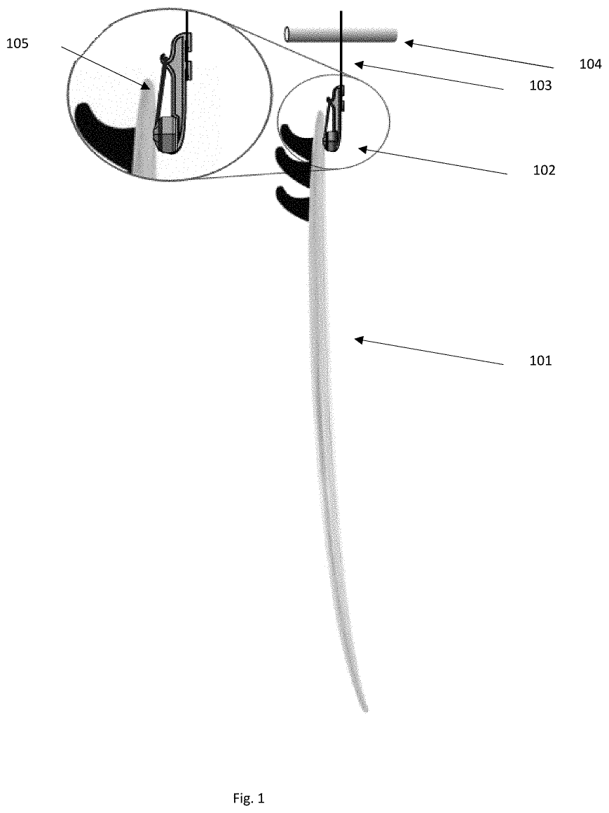

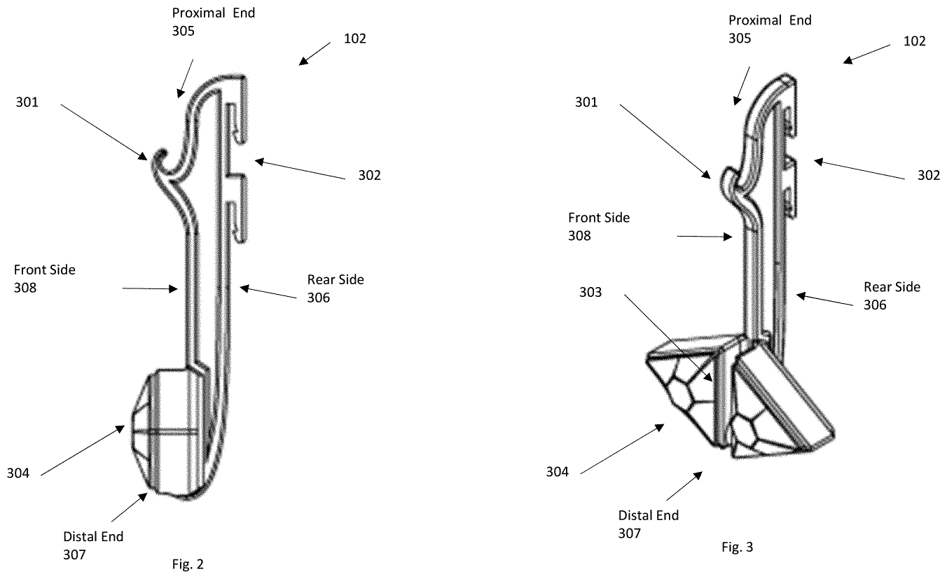

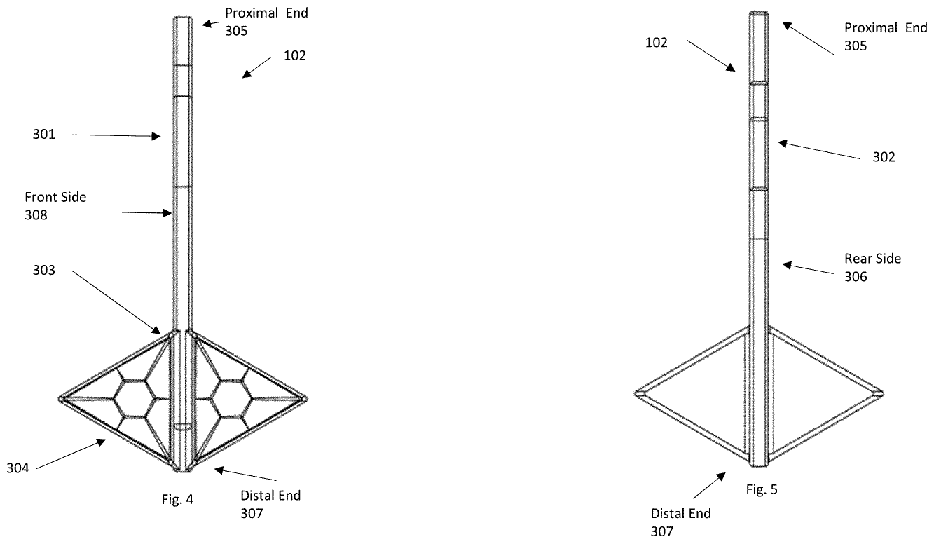

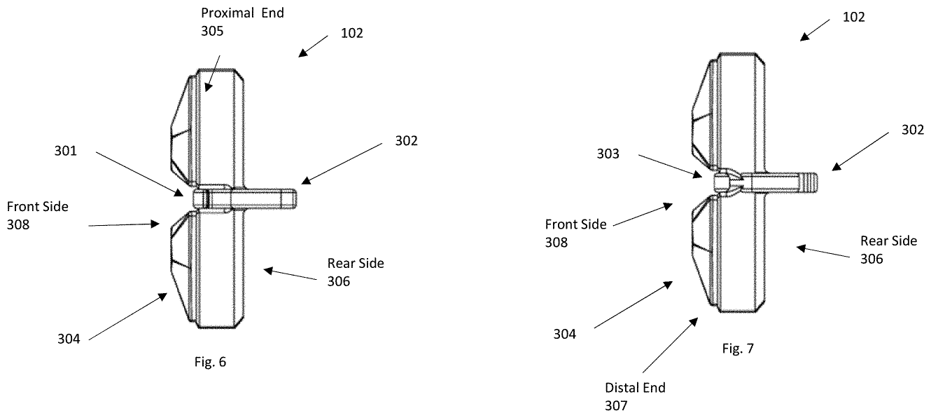

Referring to FIGS. 1-7, one exemplary embodiment of the present disclosure provides a leash rope adapter 102 with a bottom bumper 304 for hanging a surfboard 101. The adapter has a proximal end 305, a distal end 307, a front side 308 and rear side 306. The adapter 102 is preferably made of polyethylene terephthalate, aluminum, steel or a similar metal or plastic. The adapter 102 has a hooking point 301 mounted on the front side 308 of the adapter 102 towards the proximal end 305. The hooking point 301 is configured to hold a leash or a loop 105 connected to the leash plug on the surfboard 101.

A bottom bumper 304 is mounted on the front of the adapter 102 towards the distal end. The bottom bumper 304 has a face preferably made of a soft material that also has a relatively high coefficient of friction to prevent slippage. An exemplary material includes silicone rubber, neoprene rubber, butyl rubber, thermoplastic elastomer and the like. The bottom bumper 304 is preferably diamond shaped but it can also be shaped like a circle, triangle or other shape. The bottom bumper 304 is preferably attached to the adapter 102 with fasteners, adhesive, press fit or another similar means. A slit 303 bisects the bottom bumper 304 so that the leash 105 is seated in or passes through the slit 303 when the board 101 hangs from the hooking point 301.

In some embodiment, the adapter 102 also has a modular attachment point 302 on the rear of the adapter towards the proximal end 305. In this exemplary embodiment, the modular attachment point 302 may attach to one or more systems so the adapter 102 is suspended. For example, the adapter 102 may attach to a wall rack, a free standing structure or a hook for a pole. In an additional embodiment, a hanging means is attached to the rear of the adapter 102 towards the proximal end 305. The hanging means hangs from a pole or a hook 104 in order to suspend the surfboard 101.

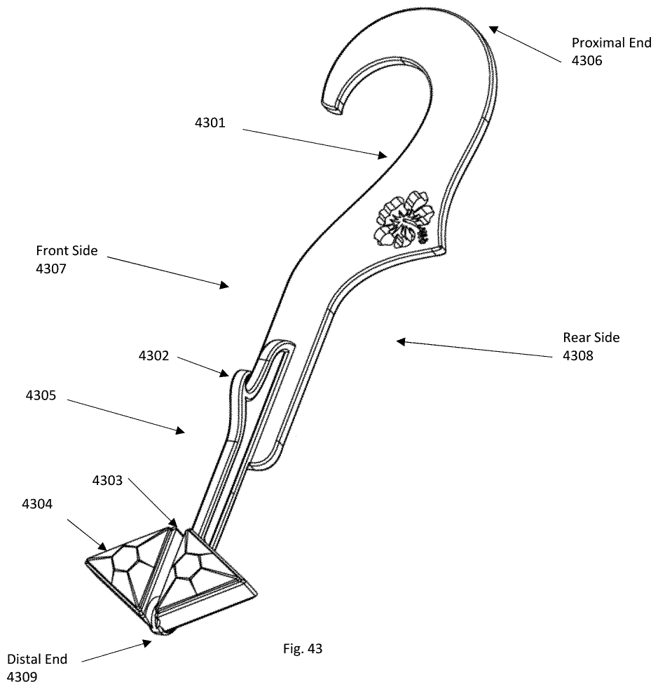

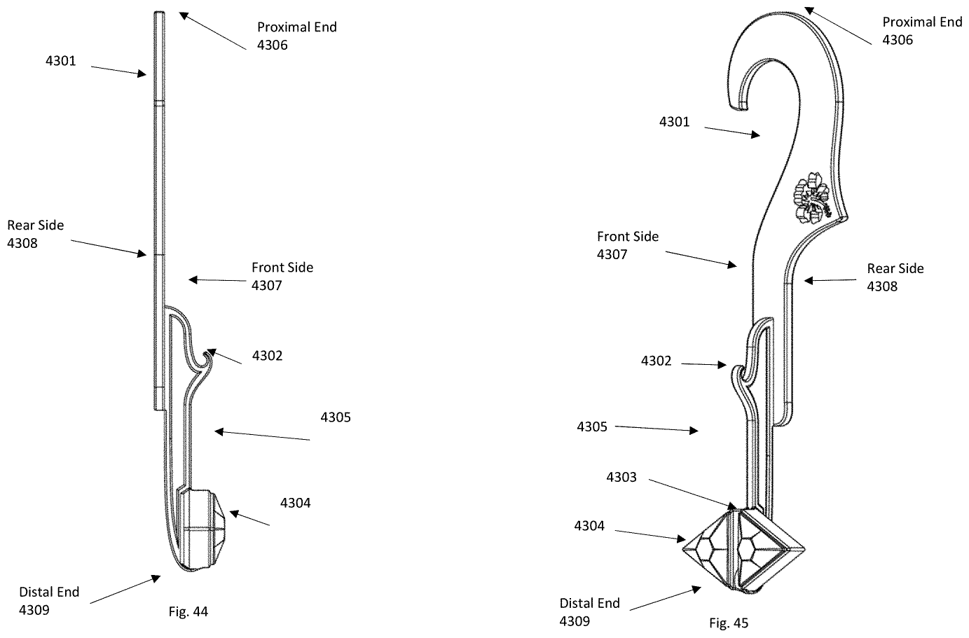

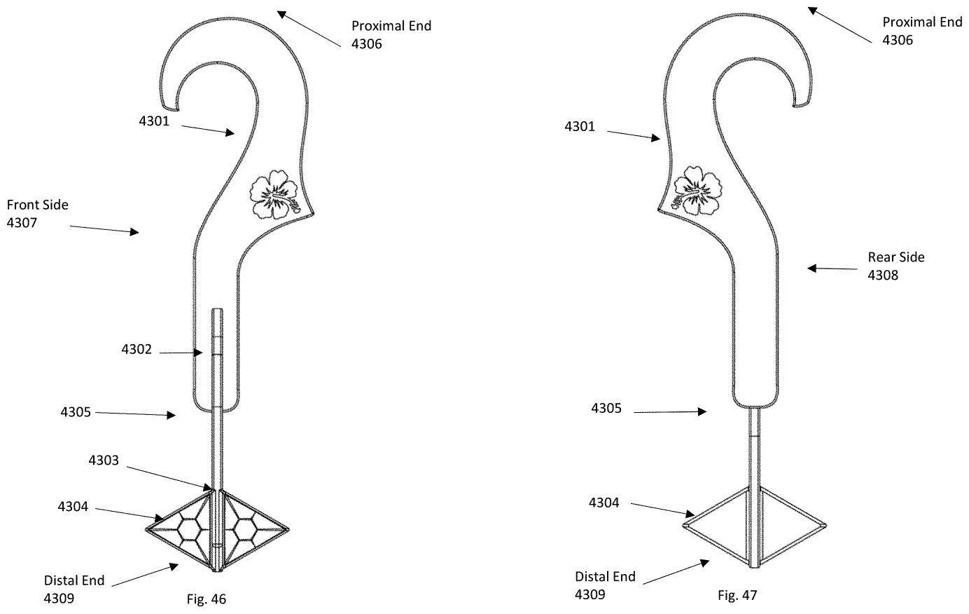

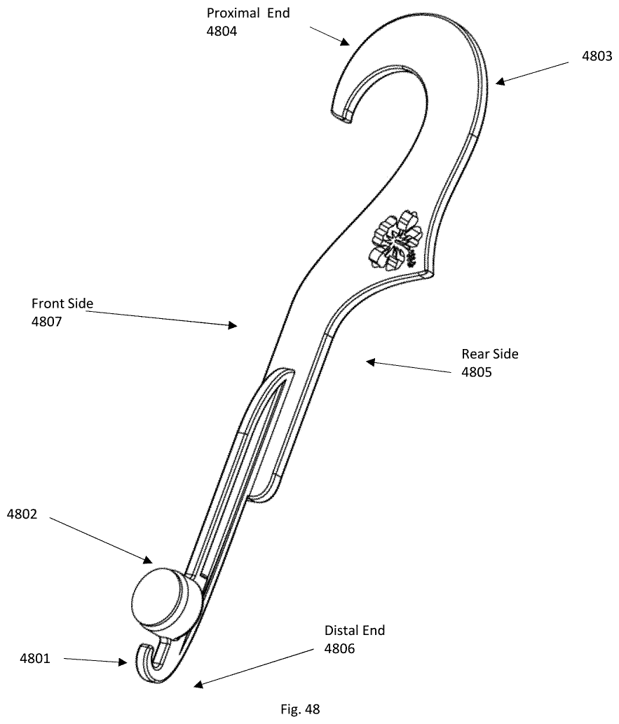

In an exemplary embodiment, as shown in FIGS. 43-47, a hanging means 4301 is fully integrated into the adapter 4305. This embodiment is similar to the embodiment above but does not include a modular attachment point. The embodiment includes proximal end 4306 where a hook 4301 or other hanging means is attached and a distal end 4309 where the surfboard or similar object is suspended. This unified system has a leash rope adapter 4305 with a bottom bumper 4304. Similar to the above embodiment, a leash rope from a surfboard is suspended from a hooking point 4302. A slit 4303 is included in the bottom bumper 4304 to avoid the leash rope making contact with the bottom bumper 4304 and allowing the leash rope to pass through unimpeded. The leash rope adapter is installed on the front side 4307 of the embodiment. The rear side 4805 of the embodiment is substantially flat to facilitate easy storage of the embodiment. The materials this embodiment is made from is similar to the above embodiment.

Leash Rope Adapter with Top Bumper System

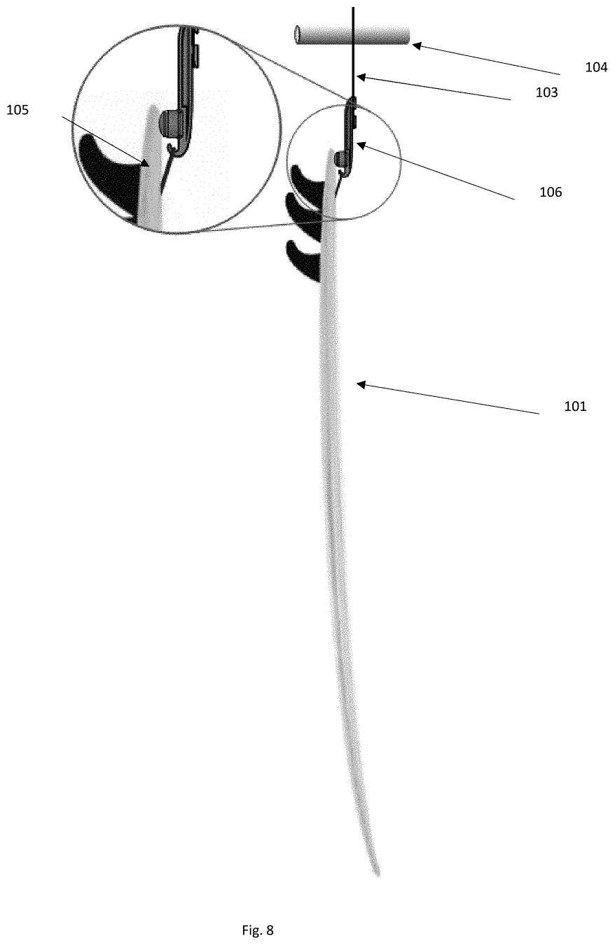

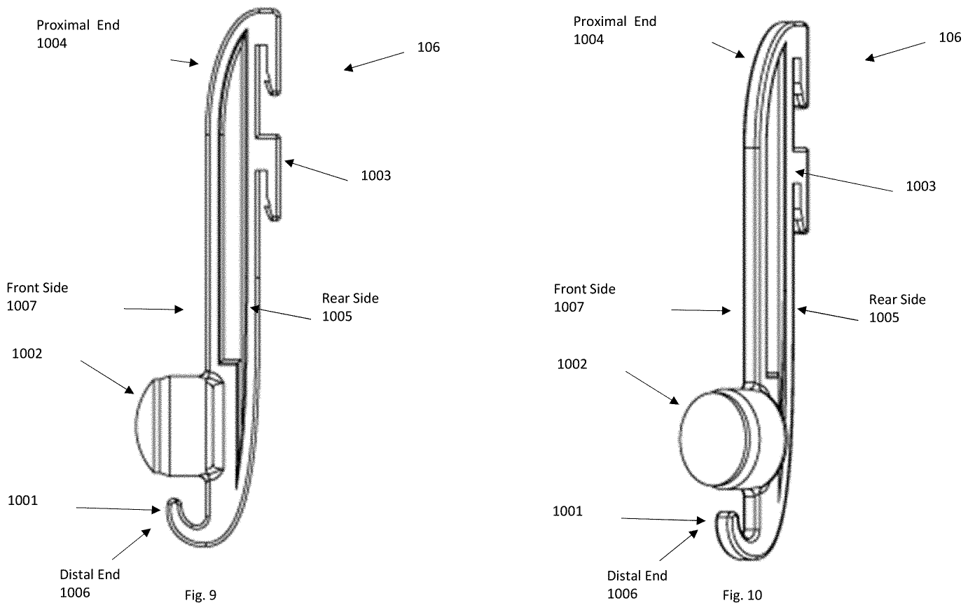

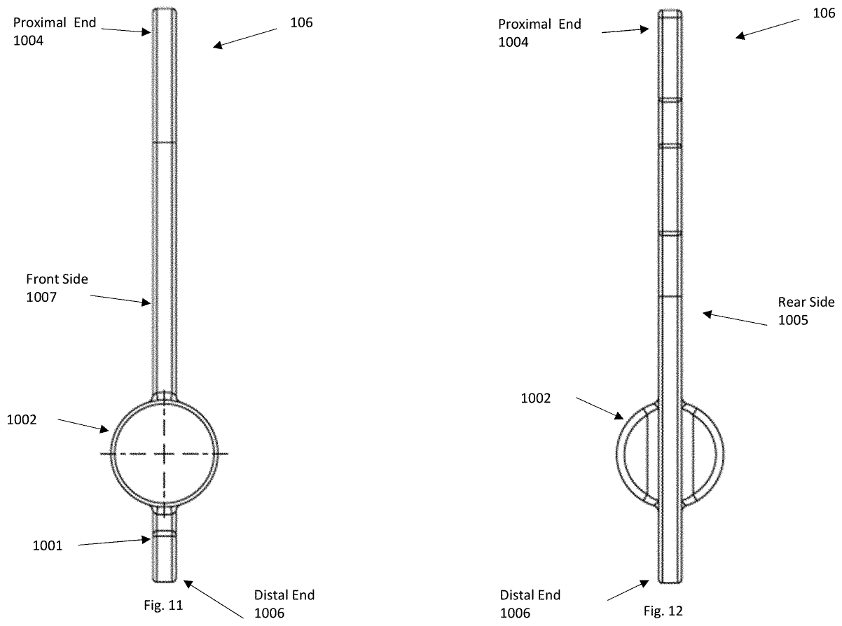

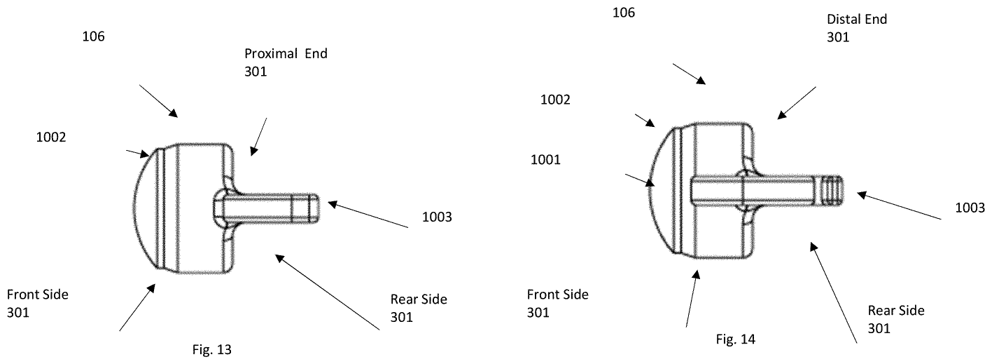

Referring to FIGS. 8-14, one exemplary embodiment of the present disclosure provides a leash rope adapter 106 with a top bumper 1002 for hanging a surfboard 101. The adapter 106 has a proximal end 1004, a distal end 1006, a front side 1007 and rear side 1005. The adapter 106 is made of polyethylene terephthalate, aluminum, steel or a similarly strong metal or plastic. The adapter 106 has a hooking point 1001 mounted on the front side 1007 of the adapter 106 towards the distal end 1006. The hooking point 1001 is configured to hold a leash or a loop 105 connected to the leash plug on the surfboard 101.

A top bumper 1002 is mounted on the front side 1007 of the adapter 106 towards the proximal end 1004. The top bumper 1002 has a face made of a soft material that also has a relatively high coefficient of friction to prevent slippage. The top bumper 1002 is preferably attached to the adapter 106 with fasteners, adhesive, press fit or another similar means. The top bumper 1002 has a face preferably made of a soft material that also has a relatively high coefficient of friction to prevent slippage. An exemplary soft material includes silicone rubber, neoprene rubber, butyl rubber, thermoplastic elastomer and the like.

The adapter 1002 also preferably has a modular attachment point 1003 on the rear side 1005 of the adapter towards the proximal end 1004. In an exemplary embodiment, the modular attachment point 1003 may attach to one or more systems so the adapter 106 is suspended. For example, the adapter 106 may attach to a wall rack, a free standing structure or a hook on a pole 104. In an additional embodiment, a hanging means, including one or more hooks, is attached to the rear of the adapter 106 towards the proximal end 1004. The hanging means hangs from a pole or a hook 104 in order to suspend the surfboard 101.

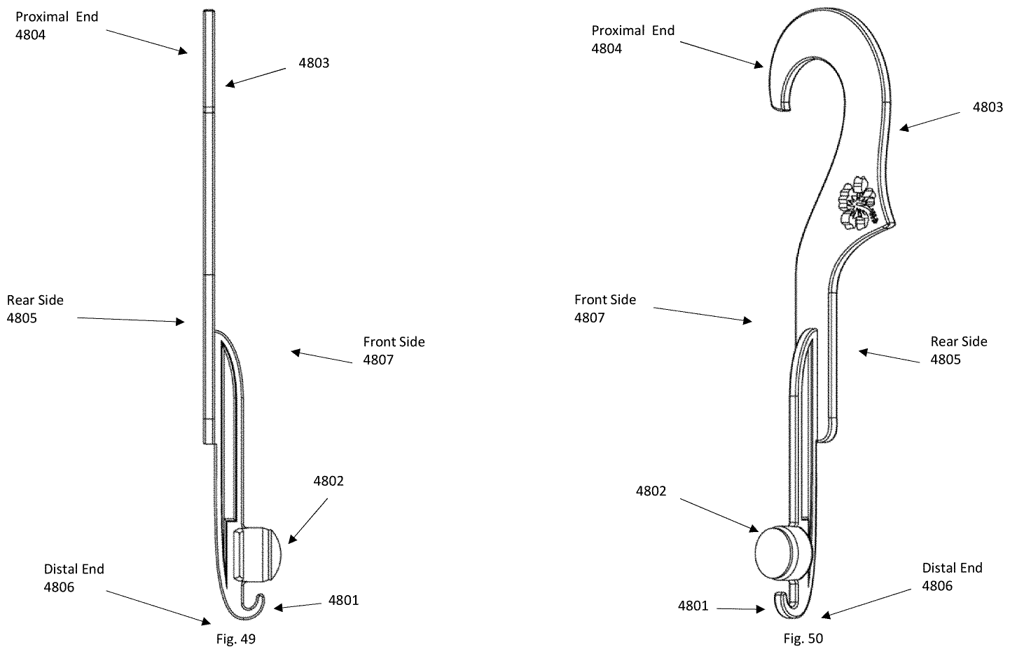

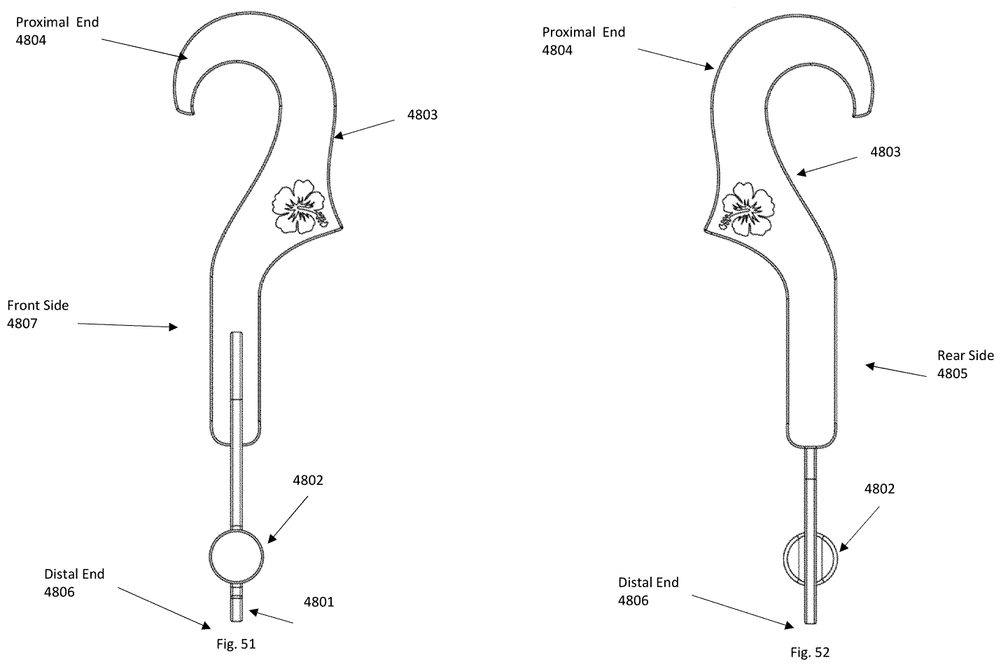

In an exemplary embodiment, as shown in FIGS. 48-52, a hanging means is fully integrated into the leash rope adapter. This embodiment does not include a modular attachment point. The embodiment includes proximal end 4804 where a hook 4803 or other hanging means is attached and a distal end 4806 where the surfboard or similar object is suspended. This unified system has a leash rope adapter with a top bumper 4802. Similar to the above embodiment, a leash rope from a surfboard is suspended from a hooking point 4801. The leash rope adapter is installed on the front side 4807 of the embodiment. The rear side 4805 of the embodiment is substantially flat to facilitate easy storage of the embodiment. The materials this embodiment is made from is similar to the above embodiment.

Leash Plug Hook

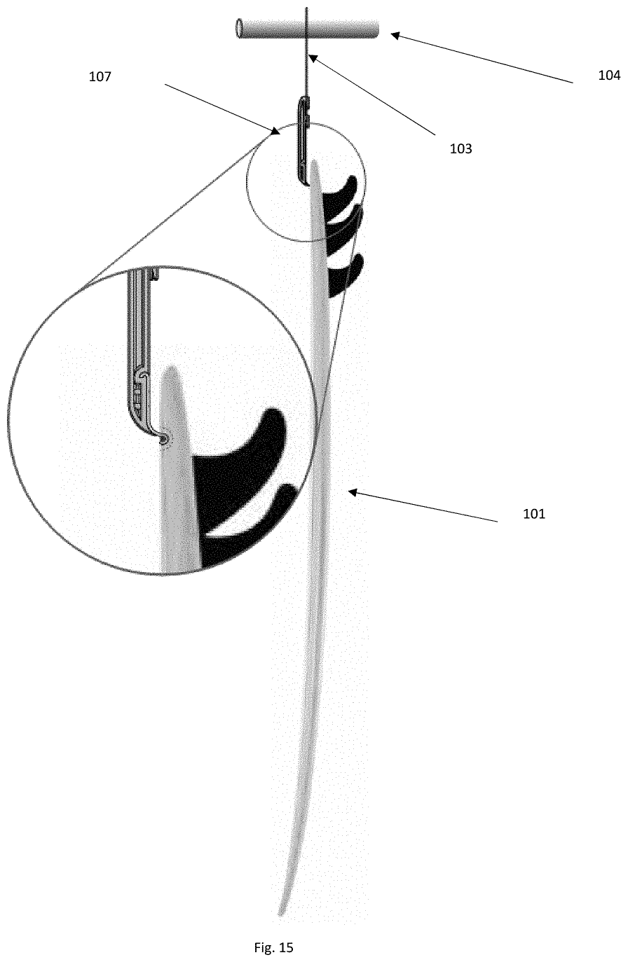

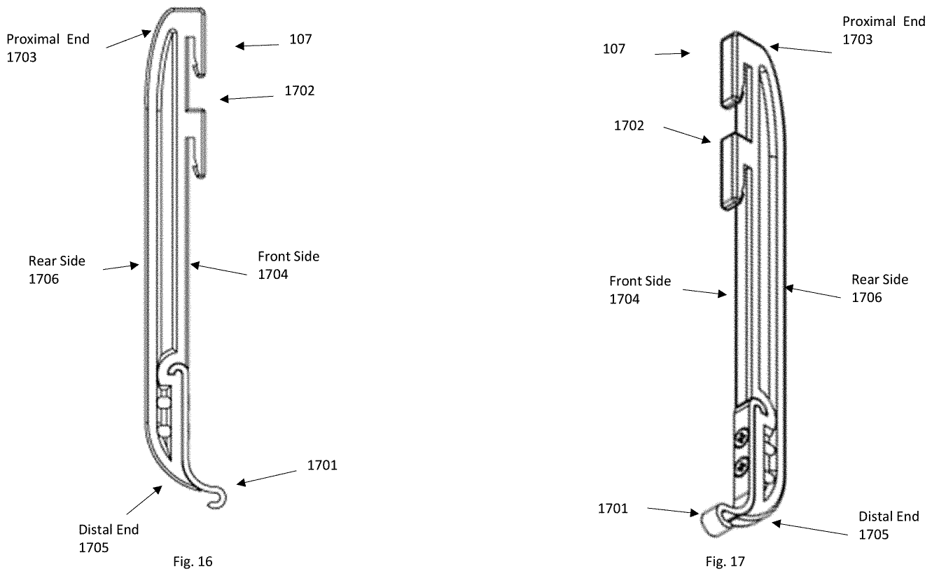

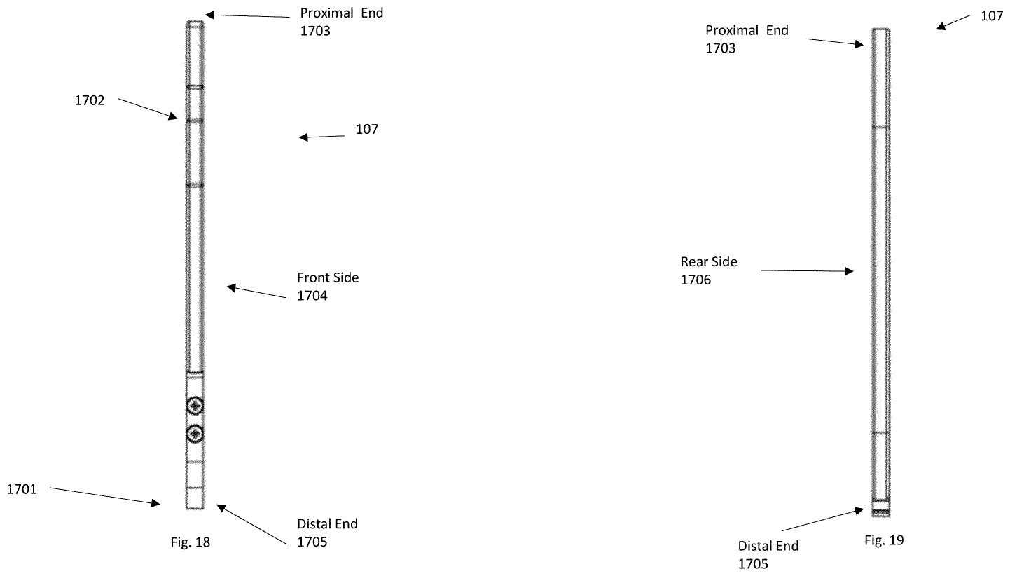

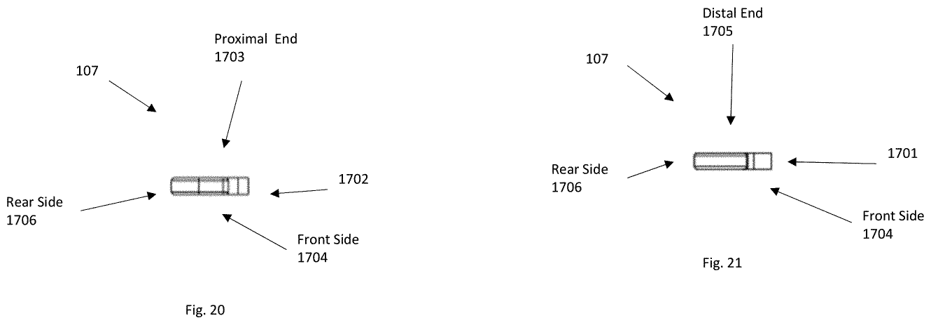

Referring to FIGS. 15-21, one exemplary embodiment of the present disclosure provides a leash plug hook 107 for hanging a surfboard 101. The adapter 107 has a proximal end 1703, a distal end 1705, a front side 1704 and rear side 1706. The adapter 107 has a hooking point 1701 mounted on the front side 1704 of the adapter towards the distal end 1705. The adapter 107 is made of polyethylene terephthalate, aluminum, steel or a similarly strong metal or plastic. The hooking point 1701 is attached to the adapter with fasteners, adhesive or another similar means. The hooking point 1701 is configured to hold a leash plug connected to the rear surface of the surfboard 101.

The adapter 107 also has a modular attachment point 1702 on the front side 1704 of the adapter 107 towards the proximal end 1703. In an exemplary embodiment, the modular attachment point 1003 may attach to one or more systems so the adapter 107 is suspended. For example, the adapter may attach to a wall rack, a free standing structure or a hook on a pole 107. In an additional embodiment, a hanging means, including one or more hooks, is attached to the rear side 1706 of the adapter towards the proximal end 1703. The hanging means hangs from a pole or a hook 104 in order to suspend the surfboard 101.

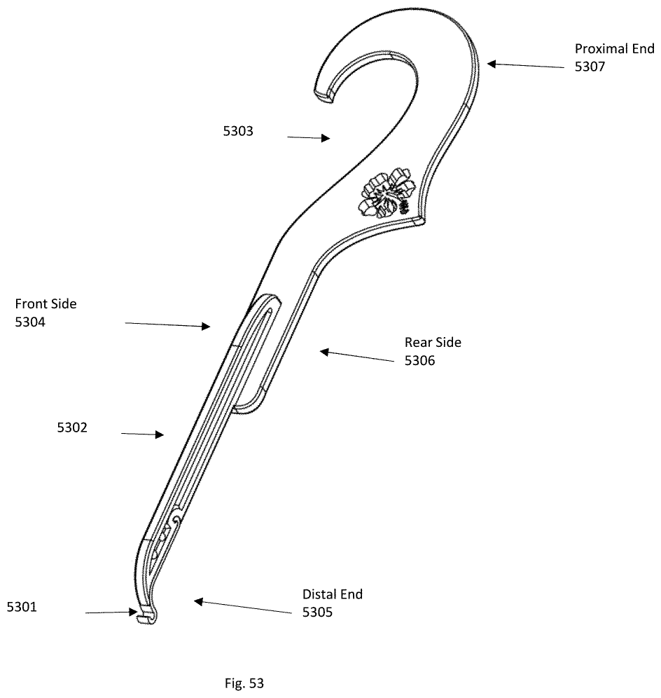

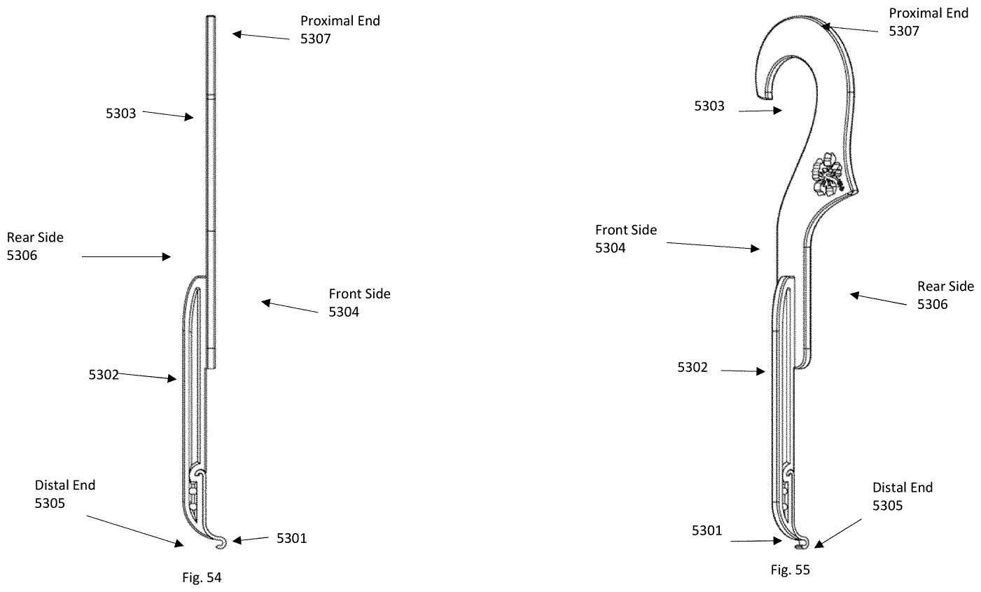

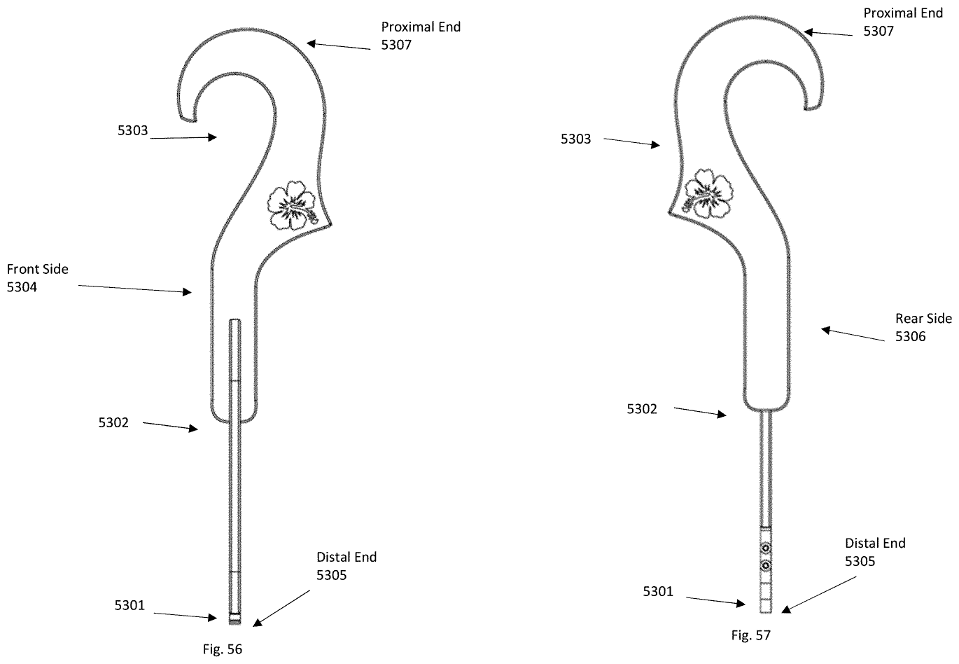

In an exemplary embodiment, as shown in FIGS. 53-57, a hanging means 5303 is fully integrated into the adapter. This embodiment is similar to the embodiment above but does not include a modular attachment point. The embodiment includes proximal end 5307 where a hook 5303 or other hanging means is attached and a distal end 5305 where the surfboard or similar object is suspended. This unified system has a leash plug hook 5302. Similar to the above embodiment, a leash plug installed into the surface of a surfboard is suspended from a hooking point 5301. The leash plug hook 5302 is installed on the front side 5304 of the embodiment. The rear side 5306 of the embodiment is substantially flat to facilitate easy storage of the embodiment. The materials this embodiment is made from is similar to the above embodiment.

Modular Attachment

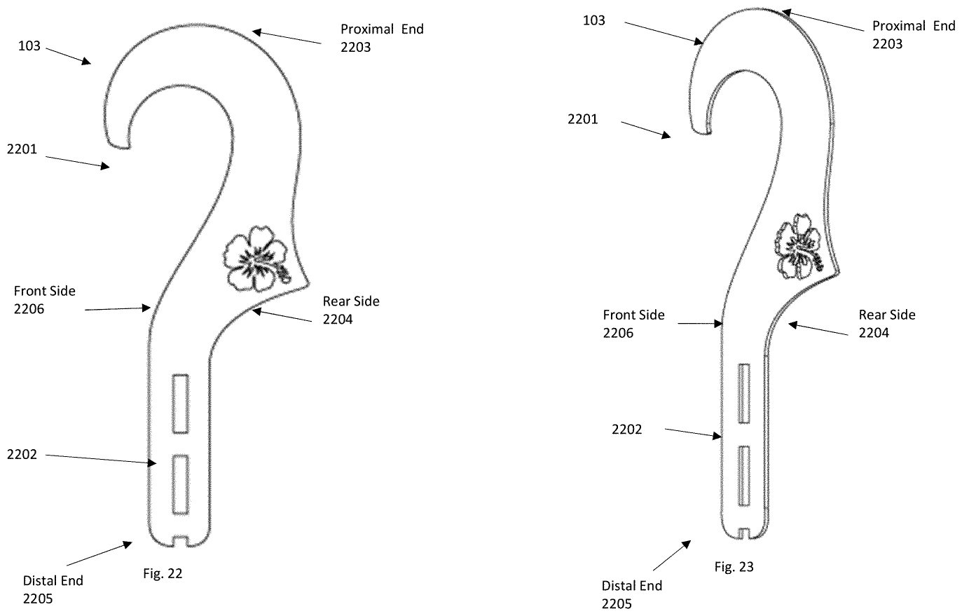

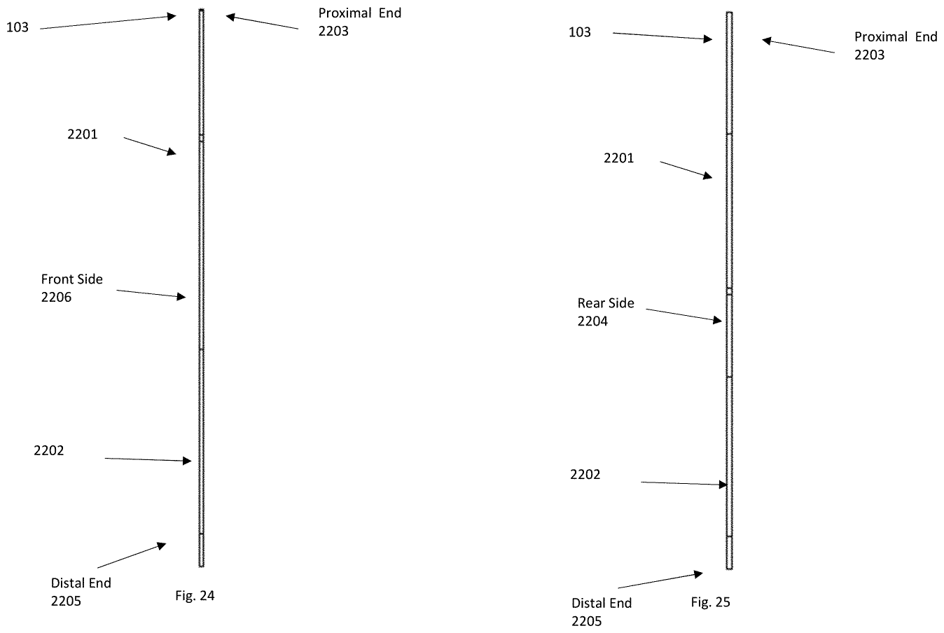

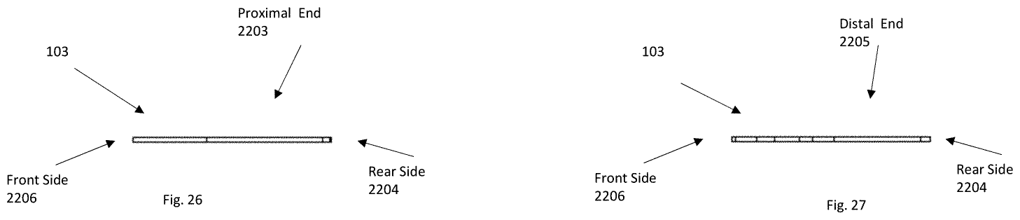

Referring to FIGS. 22-27, one exemplary embodiment of the present disclosure provides a modular hanging unit 103 for attaching to the above adapters. The modular hanging unit has a proximal end 2203, a distal end 2205, a front side 2206 and rear side 2204. The modular hanging unit 103 has a hook 2201 on the proximal end 2203 of the unit facing forward. The hooking point 2201 is configured to hook onto a pole, hook or a similar means 104 of suspending the surfboard 101.

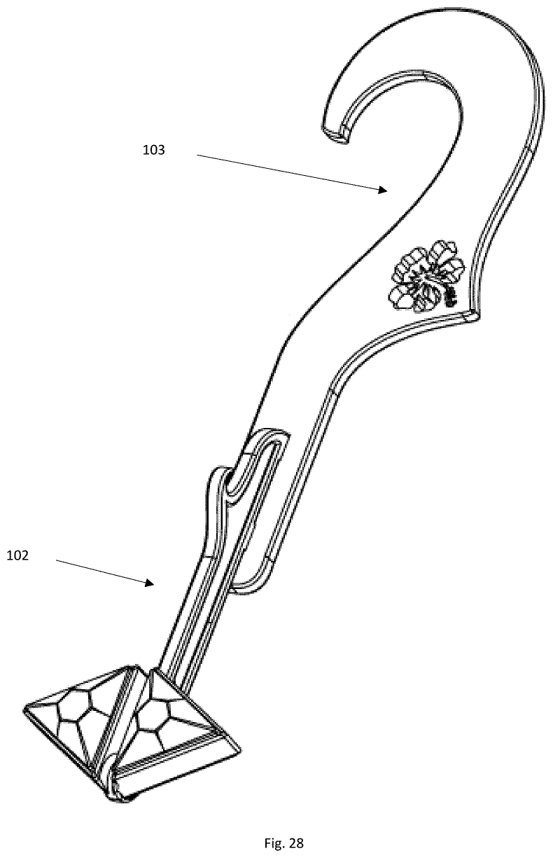

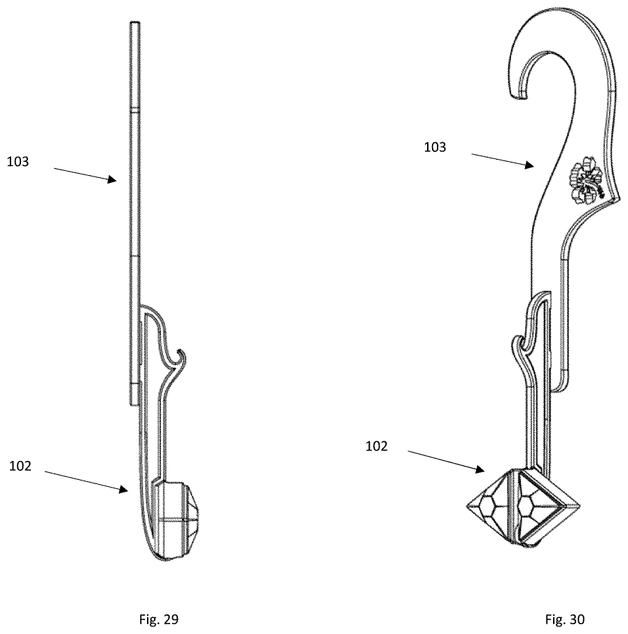

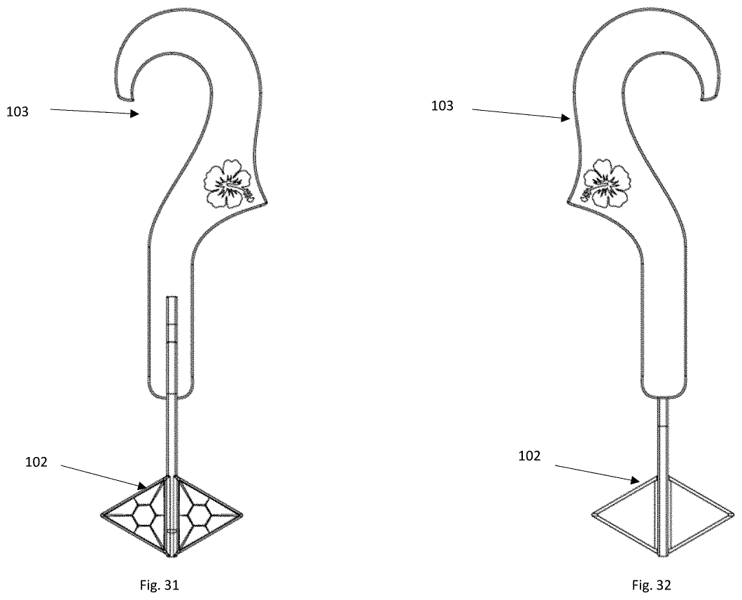

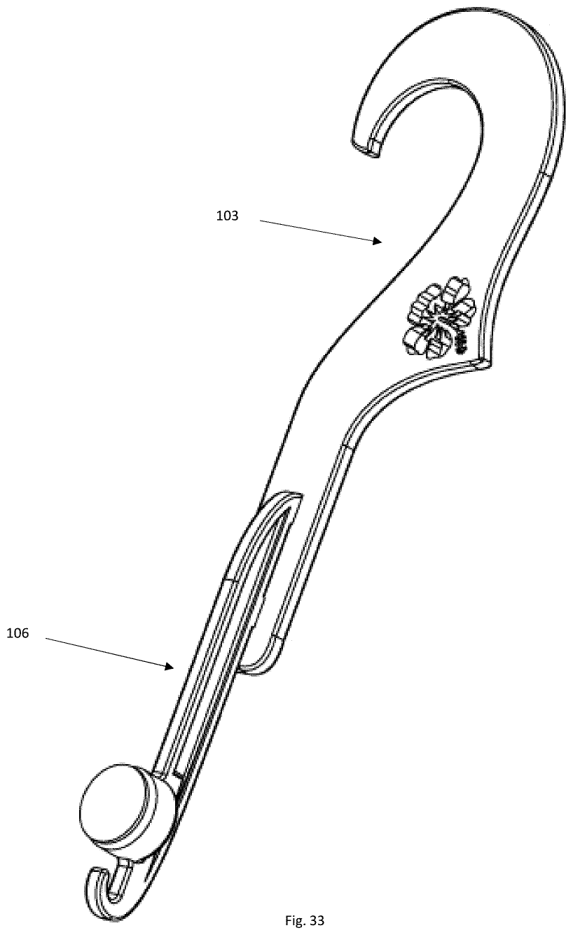

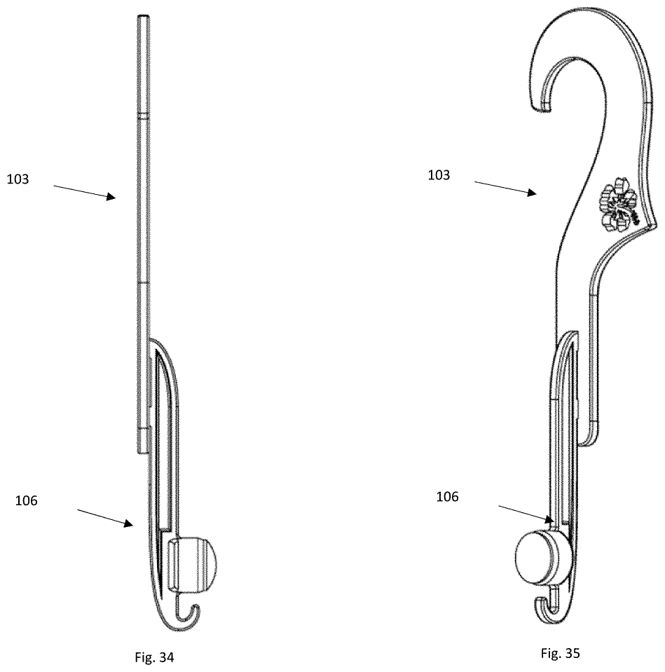

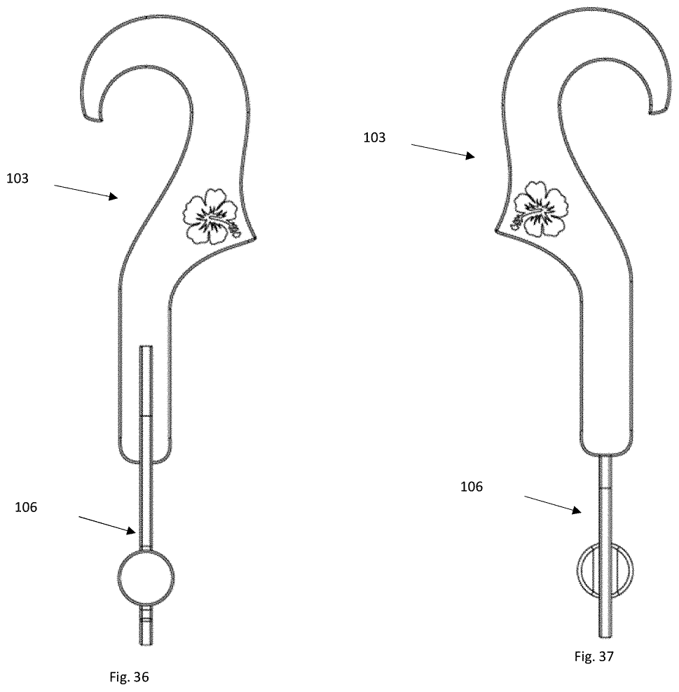

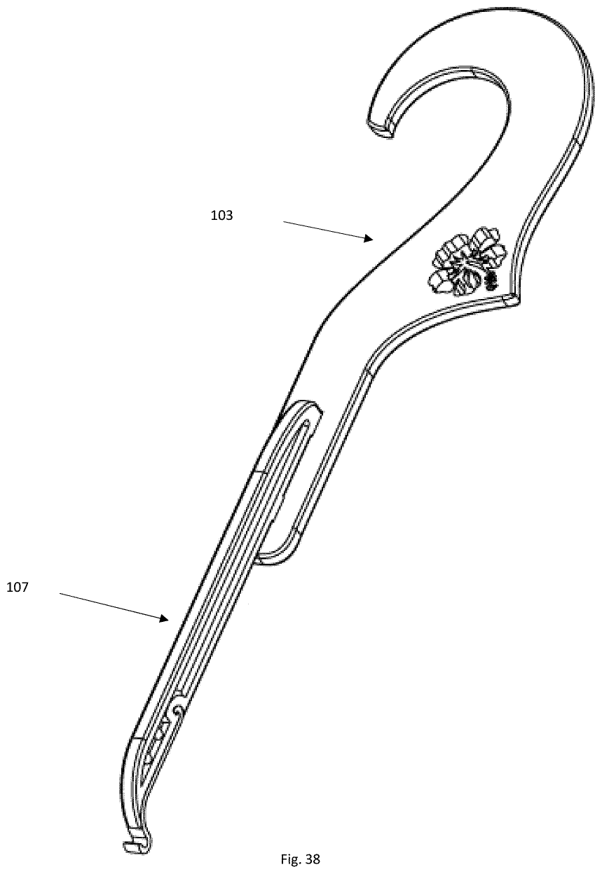

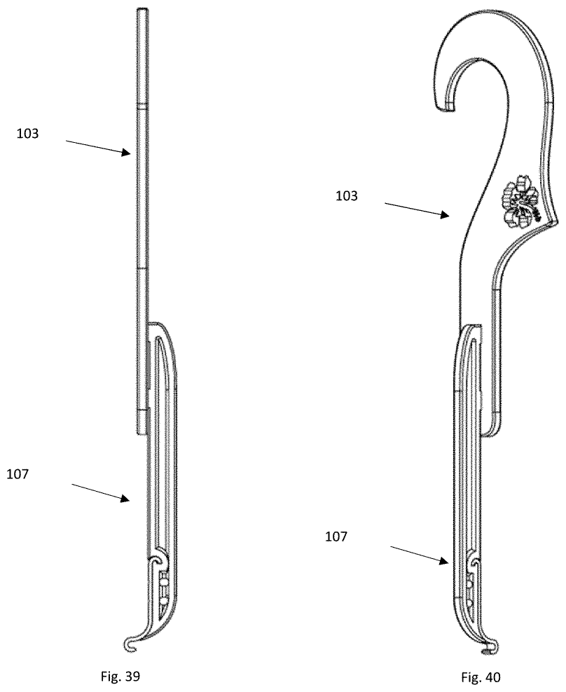

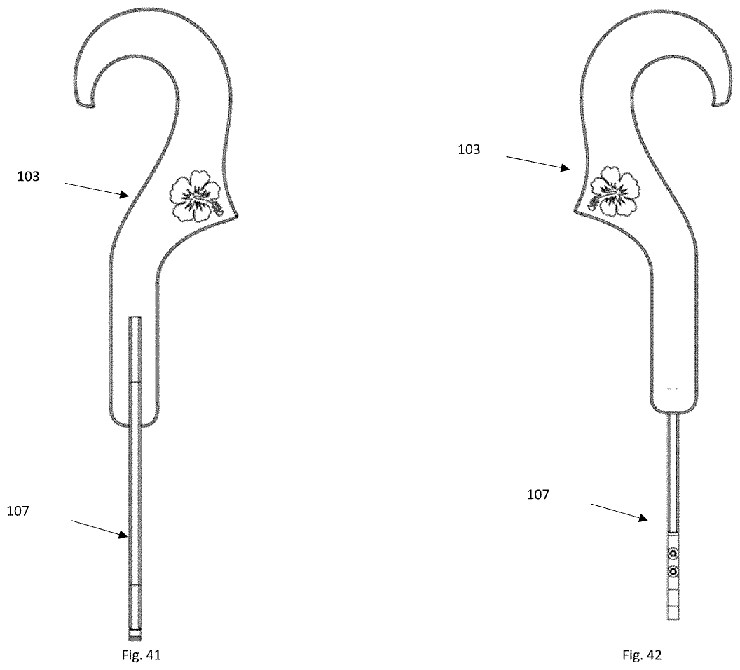

The modular hanging unit 103 also has a socket 2202 to receive the modular attachment point from any of the above adapters. While the socket 2202 is configured to receive the modular attachment point as described in the embodiments above, the modular attachment point may also connect to other devices including wall racks, car racks, a receptacle built into a wall or similar. FIGS. 28-32 are an exemplary embodiment of the leash rope adapter with a top bumper 102 connected to the modular hanging unit. FIGS. 33-37 are an exemplary embodiment of the leash rope adapter with a bottom bumper 106 connected to the modular hanging unit. FIGS. 38-42 are an exemplary embodiment of the leash plug hook 107 connected to the modular hanging unit.

It should be understood that this description (including the figures) is only representative of some illustrative embodiments. For the convenience of the reader, the above description has focused on representative samples of all possible embodiments, and samples that teach the principles of the disclosure. The description has not attempted to exhaustively enumerate all possible variations. That alternate embodiments may not have been presented for a specific portion of the disclosure, or that further undescribed alternate embodiments may be available for a portion, is not to be considered a disclaimer of those alternate embodiments. One of ordinary skill will appreciate that many of those undescribed embodiments incorporate the same principles of the disclosure as claimed and others are equivalent.

What is claimed is:

1. A board hanging device, comprising:
An elongated member extending from a proximal end to a distal end;
a leash hook portion on a front side of the device configured to hold the board;
a bumper portion on the front side of the device configured to rest against the board; and
a modular attachment point configured to removably engage a supporting structure.

2. The elongated board hanging device according to claim 1, further comprising the modular attachment point configured to removably engage a modular hanging unit.

3. The elongate board hanging device according to claim 1, further comprising an integrally molded modular hanging unit adapted to support the board.

4. The elongated board hanging device according to claim 1, wherein the leash hook is configured to hold a leash or loop attached to a leash plug on the surfboard and the bumper is configured to contact a rear end of the surfboard.

5. The elongated board hanging device according to claim 4, wherein the elongated board hanging device has a proximal end and a distal end;
wherein the bumper portion is near the distal end and the leash hook portion is near the proximal end.

6. The elongated board hanging device according to claim 5, wherein the bumper portion includes a channel bisecting the bumper portion and configured to receive a leash or rope attached to the board.

7. The elongated board hanging device according to claim 4, wherein the elongated board hanging device has a proximal end and a distal end;
wherein the bumper portion is near the proximal end and the leash hook portion is near the distal end.

8. The elongated board hanging device according to claim 1, comprising:
the surface of the bumper is coated with a high friction material configured to prevent the surfboard from sliding or being scratched or damaged.

9. The elongated board hanging device according to claim 1, wherein the device is constructed of polyethylene terephthalate, aluminum or steel.

10. The elongated board hanging device according to claim 1, wherein the modular attachment point is configured to connect to a modular hanging unit, the modular hanging unit has a hook at a proximal end configured to hang from a poll and an adapter on the distal end to receive the modular attachment point.

11. An elongated board hanging device, comprising:
a hook portion on a front side of the device configured to hold the board; and
a modular attachment point on a rear side of the device.

12. The elongated board hanging device according to claim 11, wherein the hook is configured to attach to a leash plug integrated into a rear end of the board.

13. The elongated board hanging device according to claim 11, wherein the device is constructed of polyethylene terephthalate, aluminum or steel.

14. The elongated board hanging device according to claim 11, wherein the modular attachment point is configured to connect to a modular hanging unit, the modular hanging unit has a hook at a proximal end configured to hang from a poll and an adapter on the distal end configured to receive the modular attachment point.
